(19) United States
(12) Patent Application Publication
(10) Pub. No.: US 2020/0036135 A1
(43) Pub. Date: Jan. 30, 2020

(54) Guiding Arrangement For Securely Guiding A Communication Card Into A Multi-Pin Connector

(71) Applicant: Appleton Grp LLC, Rosemont, IL (US)

(72) Inventors: Gajanan R. Muttepawar, Pune (IN); Ajit D. Athavale, Pune (IN); Raymond A. Dubiel, Palatine, IL (US)

(21) Appl. No.: 16/405,739

(22) Filed: May 7, 2019

(30) Foreign Application Priority Data
Jul. 24, 2018 (IN) 201821027831

(51) Int. Cl. H01R 13/631; H01R 13/627

(52) U.S. Cl. CPC H01R 13/631; H01R 13/6273

(57) ABSTRACT

The present disclosure relates to the field of guiding arrangements for a communication card. The guiding arrangement (200, 300), of the present disclosure, prevents deformation of the pins of a connector while guiding a communication card. The guiding arrangement (300) comprises a first guiding and aligning means and a second guiding and aligning means configured to securely guide and align a communication card with the pins of the connector to connect the card to the connector. The first guiding and aligning means includes a pair of guiding members (310) configured to be slid into a pair of channels configured on the communication card. The second guiding and aligning means includes a first snap (325) and a pair of second snaps (330) configured to abut the communication card when the communication card is guided along an axial plane of the pins of the connector.

### RELATED APPLICATIONS

This application claims priority to Indian Application No. 201821027831 entitled “A Guiding Arrangement for Securely Guiding a Communication Card Into a Multi-Pin Connector” filed on Jul. 24, 2018, the entire contents of which are incorporated by reference herein.

### FIELD

The present disclosure relates to the field of guiding arrangements for a communication card.

### BACKGROUND

The background information herein below relates to the present disclosure but is not necessarily prior art.

Conventionally, a bracket is used to guide a communication card for mating with a connector. For example, in the case of an uninterrupted power supply (UPS), a communication card is communicatively coupled to the UPS via a connector which is soldered/mounted on a printed circuit board (PCB) of the UPS. For enabling the electrical communication between the communication card and the PCB of the UPS, the communication card is guided into the connector using the bracket such that a plurality of pins of the connector gets inserted in a plurality of apertures on the communication card. A conventional bracket has prongs that engage with an inner portion of the UPS housing. Further, the conventional bracket has a primary guide that guides the communication card for mating with the connector. However, there is a play between the communication card and the bracket during insertion of the card. This can cause misalignment of the apertures of the card with the pins of the connector while inserting the card in the bracket. If the card is forcibly inserted despite being misaligned with the connector, the pins get bent. Bending of the pins leads to complete failure of the connector and the communication card can not communicate with the PCB of the UPS. Bent pins are incapable of re-receiving the apertures of the card. Reinsertion of the card into the bent pins is difficult and can permanently damage the connector, thereby failing to establish electrical connection between them.

Therefore, there is felt a need of a guiding arrangement that alleviates the aforementioned drawbacks of the conventional brackets and securely guides a communication card into a multi-pin connector.

### OBJECTS

Some of the objects of the present disclosure, which at least one embodiment herein satisfies, are as follows:

An object of the present disclosure is to provide a guiding arrangement that securely guides a communication card into a multi-pin connector.

Another object of the present disclosure is to provide a guiding arrangement that prevents bending of the pins of a connector while guiding a communication card.

Another object of the present disclosure is to provide a guiding arrangement that aligns a communication card with a connector before engaging the communication card with the connector.

Yet another object of the present disclosure is to provide a guiding arrangement that is cost effective.

Yet another object of the present disclosure is to provide a guiding arrangement that is easy to install.

Still another object of the present disclosure is to provide a guiding arrangement that can be easily retrofitted in existing applications.

Other objects and advantages of the present disclosure will be more apparent from the following description, which is not intended to limit the scope of the present disclosure.

### SUMMARY

The present disclosure envisages a guiding arrangement for guiding a communication card into a multi-pin connector. The guiding arrangement comprises a first guiding and aligning means configured to securely guide a plurality of apertures of the communication card into a plurality of pins of the connector.

In an embodiment, the first guiding and aligning means includes a pair of guiding members arranged opposite to each other. The pair of guiding members is configured to be slid into a pair of channels configured on the communication card. The first guiding and aligning means further includes a plurality of stiffeners configured to support the pair of guiding members. Further, the first guiding and aligning means includes a pair of support members arranged opposite to each other. The pair of support members is configured to support the connector thereon.

The guiding arrangement further comprises a second guiding and aligning means configured to guide the communication card along an axial plane of the plurality of pins.

In an embodiment, the second guiding and aligning means includes a first snap configured to abut the communication card when the communication card is guided along an axial plane of the plurality of pins. The second guiding and aligning means further includes a pair of second snaps configured to abut and guide the communication card when the communication card is guided along the axial plane of the plurality of pins. The plane of the second snaps is orthogonal to the plane of the first snap.

In another embodiment, the first and second guiding and aligning means are configured on a bracket. In an embodiment, each of the bracket, the first and the second guiding and aligning means is of a non-metallic material.

The bracket comprises a support portion and a plurality of arms extending orthogonally from the support portion. The first guiding means is configured on the plurality of arms, and the second guiding means is configured on the support portion and the plurality of arms.

### BRIEF DESCRIPTION OF THE ACCOMPANYING DRAWING

A guiding arrangement for guiding a communication card into a multi-pin connector, of the present disclosure, will now be described with the help of the accompanying drawing, in which:

FIG. 1 illustrates an isometric view of a conventional bracket;

FIG. 2 illustrates an exploded view of an assembly of the conventional bracket of

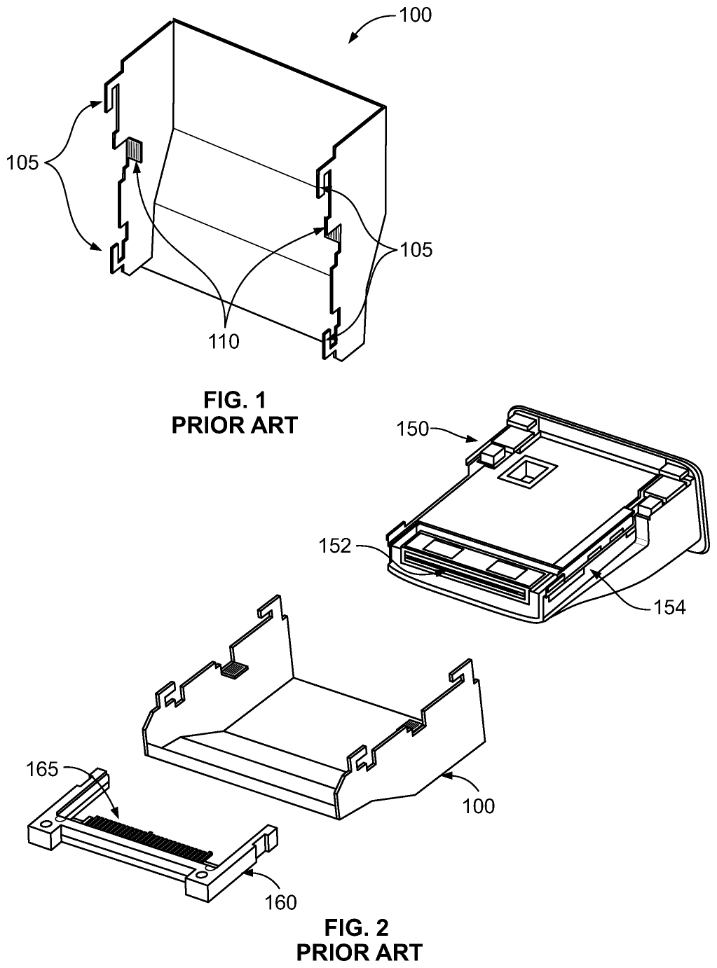

FIG. 1, a connector and a communication card;

FIG. 3 illustrates an isometric view depicting insertion of a communication card into the conventional bracket of FIG. 1;

FIG. 4 illustrates an isometric view of a guiding arrangement, in accordance with the first aspect of the present disclosure;

FIG. 5 illustrates an isometric view of a guiding arrangement, in accordance with the second aspect of the present disclosure;

FIG. 6 illustrates another isometric view of the guiding arrangement of FIG. 5;

FIG. 7 illustrates yet another isometric view of the guiding arrangement of FIG. 5; and

FIG. 8 illustrates still another isometric view of the guiding arrangement of FIG. 5.

### LIST OF REFERENCE NUMERALS

100—Conventional bracket
105—Prongs
110—Primary guide
150—Communication card
152—Apertures
154—Pair of channels
160—Connector
165—Pins
170—Inner wall of UPS housing
200, 300—Guiding arrangement
205—Frame
210—First guiding and aligning means
215—Guiding members
220, 345—Projections
225—Holes
230, 320—Support members
305—Bracket
306—Support portion
307—Arms
308—Slot
310—Guiding members
315—Stiffeners
325—First snap
330—Second snaps
335—Slots
340—Holes
350—Hole

### DETAILED DESCRIPTION

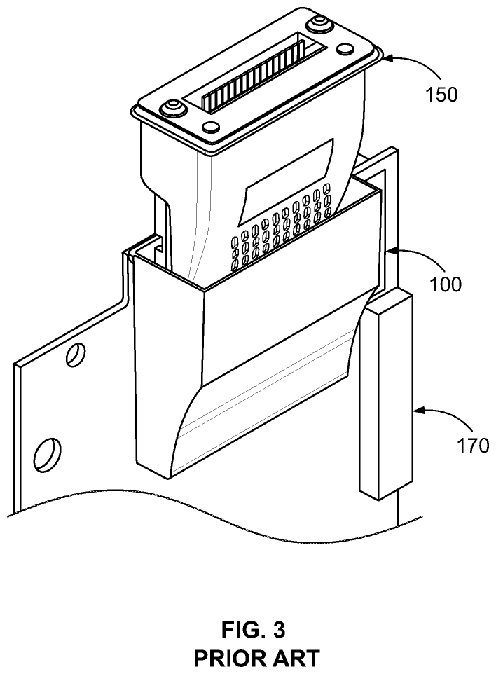

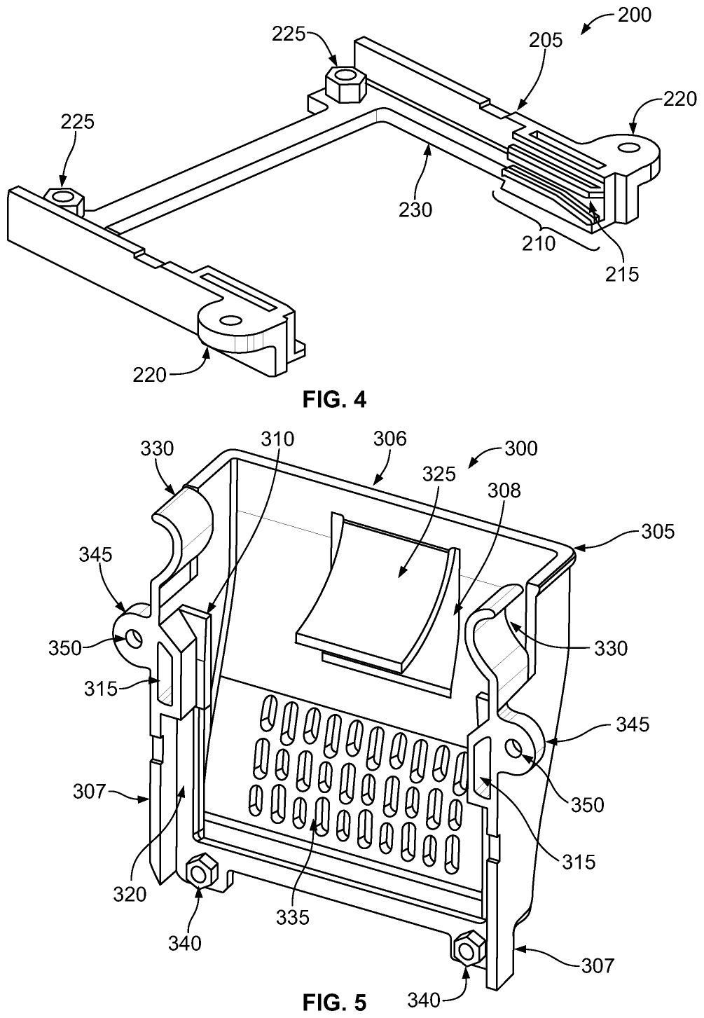

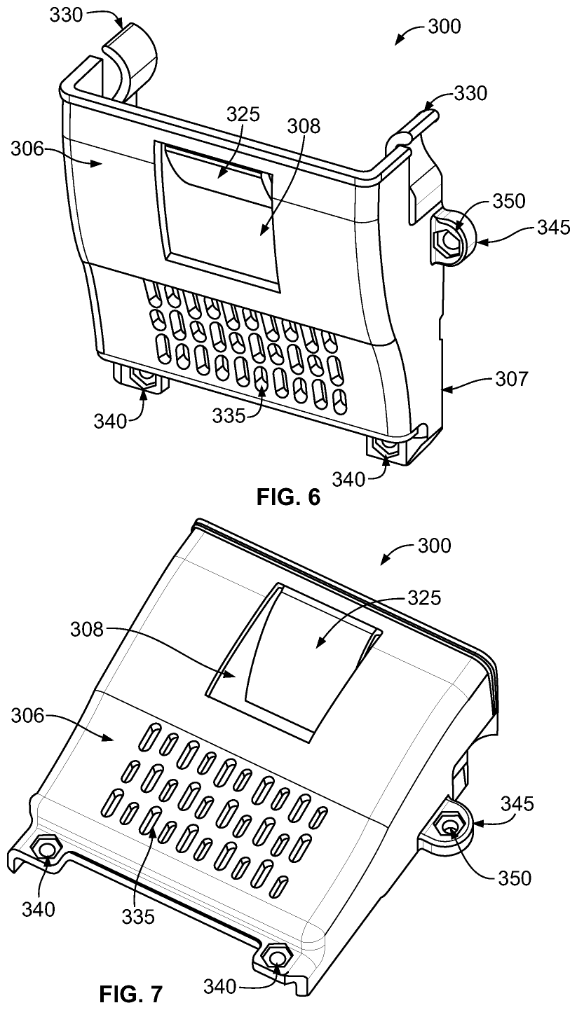

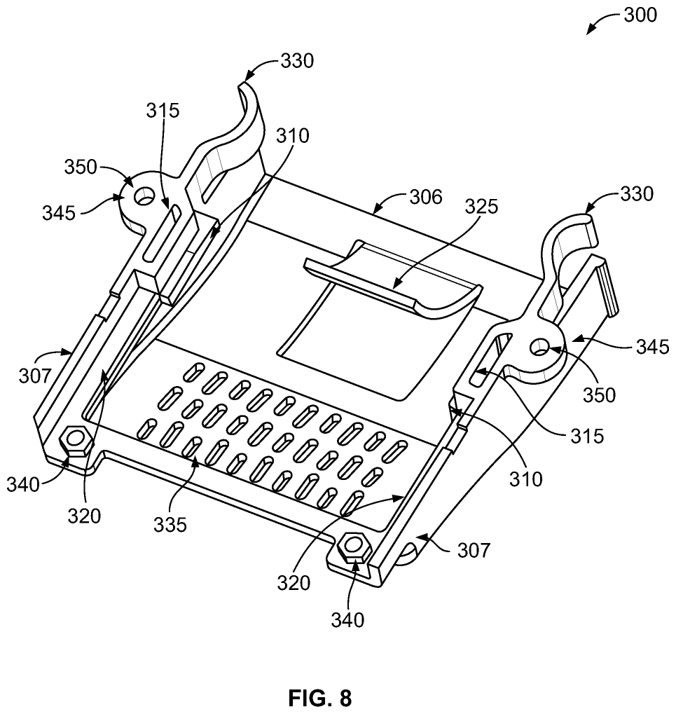

Referring to FIG. 1, FIG. 2, and FIG. 3, a conventional bracket 100 (hereinafter also referred to as bracket 100) is shown. The bracket 100 is typically used to guide a communication card 150 for mating with a connector 160 mounted on a printed circuit board (PCB) of a UPS (not specifically shown in figures). Typically, the PCB is mounted on an inner wall 170 of the UPS housing. The connector 160 is soldered to the printed circuit board (PCB) of the UPS, and facilitates communication between the communication card 150 and the PCB of the UPS. Generally, the connector 160 is mounted on the PCB. The connector 160 has a plurality of pins 165 which is received in a plurality of apertures 152 configured on the communication card 150. To connect the communication card 150 to the connector 160, the communication card 150 is guided using the bracket 100 (as shown in FIG. 3). Typically, the bracket 100 is of a metallic material. The bracket 100 has prongs 105 that are engaged with the inner wall 170 of the UPS housing, thereby facilitating mounting of the bracket 100 in the UPS. The bracket 100 comprises a primary guide 110 in the form of a pair of projections directed inwardly. When the communication card 150 is inserted in the bracket 100, the primary guide 110 guides the communication card 150 by sliding along a channel 154 configured on the communication card 150. The channel 154 is configured on each of the opposite sides of the card 150. When fully inserted, the female electrical contact elements of the communication card 150 receive the male electrical contact elements of the connector 160. To properly engage the communication card 150 with the connector 160, the apertures 152 (female contact elements) on the communication card 150 need to be properly aligned with the pins 165 (male contact elements) on the connector 160. However, during inserting the communication card 150 in the bracket 100, it is observed that there is play between the bracket 100 and the communication card 150. The play can create misalignment between the apertures 152 on the communication card 150 and the pins on the connector. If the card 150 is forcibly inserted despite being misaligned with the connector 160, the pins of the connector 160 get bent. Bending of the pins leads to complete failure of the connector 160 and severely hampers the communication between the card 150 and the PCB of the UPS.

The present disclosure envisages a guiding arrangement that ensures proper alignment between apertures of a communication card and pins of a connector while guiding the communication card into the connector.

The guiding arrangement, of the present disclosure is now described with reference to FIG. 4 through FIG. 8.

FIG. 4 illustrates an isometric view of a guiding arrangement 200, in accordance with a first aspect of the present disclosure.

The guiding arrangement 200 is configured to guide a communication card, such as the communication card 150 shown in FIG. 2 into a multi-pin connector, such as connector 160 shown in FIG. 2.

The guiding arrangement 200 comprises a frame 205, and a first guiding and aligning means 210 configured on the frame 205. The first guiding and aligning means 210 is configured to securely guide a plurality of apertures 152 (shown in FIG. 2) of the communication card 150 into the connector. In an embodiment, the first guiding and aligning means 210 includes a pair of guiding members 215 arranged opposite to each other on the frame 205. The guiding members 215 are configured to be slid into a pair of channels 154 (shown in FIG. 2) configured on the communication card 150. The guiding members 215 do not allow movement of the communication card 150 along a transverse plane thereof, thereby properly aligning the apertures 152 on the card 150 with the pins 165 of the connector 160.

The frame 205 is provided with projections 220 for facilitating removable mounting of the frame 205 on the PCB of a UPS. The frame 205 includes holes 225 to facilitate mounting of the connector 160 on the frame 205. In an embodiment, fasteners are used to mount the frame 205 on the PCB and the connector 160 on the frame 205. In another embodiment, the frame 205 includes a pair of support members 230 configured to receive the connector 160 on the frame 205.

In an embodiment, each of the frame 205 and the first guiding and aligning means 210 is of a non-metallic material, preferably plastic.

Referring to FIG. 5, FIG. 6, FIG. 7, and FIG. 8, a guiding arrangement 300 in accordance with a second aspect of the present disclosure is illustrated.

The guiding arrangement 300 comprises a bracket 305, a first guiding and aligning means and a second guiding and aligning means. The bracket 305 comprises a support portion 306 and a plurality of arms 307 extending orthogonally from the support portion 306.

The first guiding and aligning means and the second guiding and aligning means are configured on the bracket 305.

The first guiding and aligning means is configured to securely guide the plurality of apertures 152 (shown in FIG. 2) of the communication card 150 (shown in FIG. 2) into the pins 165 (shown in FIG. 2) of the connector 160. In an embodiment, the first guiding and aligning means includes a pair of guiding members 310 arranged opposite to each other. The guiding members 310 are configured to be slid into a pair of channels 154 configured on the communication card 150. The width and the length of the guiding members 310 are determined such that the guiding members 310 do not allow movement of the card 150 along a transverse plane. More specifically, the card 150 has a tapered configuration. The guiding members 310 do not allow the movement of the card 150 in a plane orthogonal to the plane of insertion of the card 150.

The first guiding and aligning means includes a plurality of stiffeners 315 configured to support the pair of guiding members 310. Further, the first guiding and aligning means includes a pair of support members 320 arranged opposite to each other, and configured to support the connector 160 thereon.

In an embodiment, the first guiding and aligning means, more specifically, the guiding members 310, the stiffeners 315, and the support members 320, are configured on an inner portion of the arms 307 of the bracket 305. The support members 320 extend from the guiding members 310. The stiffeners 315 are provided on the guiding members 310. The width of the stiffeners 315 is lesser than the width of the guiding members 310 to facilitate reception of the guiding members 310 into the channels 154 of the communication card 150.

The second guiding and aligning means is configured to guide the communication card 150 along an axial plane of the pins 165 of the connector 160. The second guiding and aligning means includes a first snap 325 configured to abut the communication card 150 when the card 150 is guided along an axial plane of the pins 165 of the connector 160.

The second guiding and aligning means further includes a pair of second snaps 330 configured to abut and guide the card 150 when the card 150 is guided along the axial plane of the pins 165 of the connector 160.

In an embodiment, the plane of the second snaps 330 is orthogonal to the plane of the first snap 325.

In another embodiment, the second guiding and aligning means, more specifically, the first snap 325 and the pair of second snaps 330, are configured on the bracket 305. More specifically, the first snap 325 is configured on the support portion 306 of the bracket 305. In an embodiment, the first snap 325 is formed integral with the support portion 306. A slot 308 is provided on the support portion 306 to facilitate movement of the first snap 325. The first snap 325 abuts the card 150 when the card 150 is inserted in the bracket 305, and thus, reduces play between the bracket 305 and the card 150. Thus, the apertures 152 of the card 150 get properly aligned with the pins 165 of the connector 160.

In another embodiment, the pair of second snaps 330 is configured on the arms 307 of the bracket 305. More specifically, the second snaps 330 are formed integral with the arms 307. Each second snap 330 is provided at the end of the arm 307. The card 150 is inserted in the bracket 305 from the second snaps 330 side. The minimum distance between the second snaps 330 is lesser than the maximum transverse distance of the card 150. The second snaps 330 firmly abut the sides of the card 150, and prevent transverse/sideways movement of the card 150.

In another embodiment, the bracket 305, the first guiding and aligning means, and the second guiding means are of a non-metallic material, preferably plastic. More specifically, the bracket 305, the guiding members 310, the stiffeners 315, the support members 320, the first snap 325, and the pair of second snaps 330 are of a non-metallic material, preferably plastic.

In yet another embodiment, a plurality of slots 335 is configured on the bracket 305. The slots 335 are configured to facilitate airflow therethrough. The slots 335 are configured on the support portion 306 of the bracket 305, and aligns with the holes configured on the card when the card is fully inserted in the bracket 305. The holes on the card 150 and the slots 335 on the bracket 305 are configured to facilitate airflow therethrough in order to cool the internal components of the card 150.

The bracket 305 further comprises a pair of holes 340 configured on the bracket 305 to facilitate secure mounting of the connector 160 thereon. The connector is mounted on the bracket 305 via fasteners passing through the pair of holes 340.

The bracket 305 includes projections 345. The projections 345 extend from each of the arms 307. Each of the projections 345 is provided with a hole 350 configured thereon to facilitate mounting of the bracket 305, for example, on the PCB of the UPS.

In an operative configuration, the bracket 305 is mounted on the PCB of the UPS using fasteners such that the connector 160 is received on the support members 320. The connector 160 is connected to the PCB and fastened to the bracket 305 via fasteners. Further, the communication card 150 to be connected with the connector 160 is inserted in the space between the second snaps 330 of the bracket 305. The second snaps 330 abut the card 150 during insertion, and facilitate alignment of the apertures 152 of the card 150 with the pins 165 of the connector 160. As the card 150 is further inserted in the bracket 305, the guiding members 310 are received in the channels 154 of the card 150. The guiding members 310 do not allow the transverse movement of the card 150. Further, the first snap 325 abuts the card 150, and prevents movement of the card 150 in the plane transverse to the plane of the second snaps 330. At this stage, the apertures 152 of the card 150 are perfectly aligned with the pins 165 on the connector 160, and movement of the card 150 along planes transverse to the plane of insertion is prevented. The card 150 is further inserted in the bracket 305 until the pins 165 of the connector 160 are completely received in the apertures 152 on the card 150.

Although the present disclosure is described with reference to application of the guiding arrangement 300 in the PCB of the UPS, the present disclosure is not limited to use of the guiding arrangement in UPS. Use of the guiding arrangement in other applications is well within the scope and ambit of the present disclosure.

The guiding arrangement, of the present disclosure, prevents deformation of the pins on the connector as it facilitates proper alignment of the holes of the card with the pins of the connector. Further, the guiding arrangement is light in weight and cost effective. The guiding arrangement can be easily removed by removing the fasteners.

### TECHNICAL ADVANCEMENTS

The present disclosure described herein above has several technical advantages including, but not limited to, the realization of a guiding arrangement that:
securely guides a communication card into a multi-pin connector;
prevents deformation of the pins of a connector while guiding a communication card;
aligns a communication card with a connector before engaging the communication card with the connector;
is cost effective;
is easy to install; and
can be easily retrofitted in existing applications.

The foregoing disclosure has been described with reference to the accompanying embodiments which do not limit the scope and ambit of the disclosure. The description provided is purely by way of example and illustration.

The embodiments herein and the various features and advantageous details thereof are explained with reference to the non-limiting embodiments in the following description. Descriptions of well-known components and processing techniques are omitted so as to not unnecessarily obscure the embodiments herein. The examples used herein are intended merely to facilitate an understanding of ways in which the embodiments herein may be practiced and to further enable those of skill in the art to practice the embodiments herein. Accordingly, the examples should not be construed as limiting the scope of the embodiments herein.

The foregoing description of the specific embodiments so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the embodiments as described herein.

Throughout this specification the word “comprise”, or variations such as “comprises” or “comprising”, will be understood to imply the inclusion of a stated element, integer or step, or group of elements, integers or steps, but not the exclusion of any other element, integer or step, or group of elements, integers or steps.

The use of the expression “at least” or “at least one” suggests the use of one or more elements or ingredients or quantities, as the use may be in the embodiment of the disclosure to achieve one or more of the desired objects or results.

Any discussion of documents, acts, materials, devices, articles or the like that has been included in this specification is solely for the purpose of providing a context for the disclosure. It is not to be taken as an admission that any or all of these matters form a part of the prior art base or were common general knowledge in the field relevant to the disclosure as it existed anywhere before the priority date of this application.

The numerical values mentioned for the various physical parameters, dimensions or quantities are only approximations and it is envisaged that the values higher/lower than the numerical values assigned to the parameters, dimensions or quantities fall within the scope of the disclosure, unless there is a statement in the specification specific to the contrary.

While considerable emphasis has been placed herein on the components and component parts of the preferred embodiments, it will be appreciated that many embodiments can be made and that many changes can be made in the preferred embodiments without departing from the principles of the disclosure. These and other changes in the preferred embodiment as well as other embodiments of the disclosure will be apparent to those skilled in the art from the disclosure herein, whereby it is to be distinctly understood that the foregoing descriptive matter is to be interpreted merely as illustrative of the disclosure and not as a limitation

We claim:

1. A guiding arrangement (200, 300) for securely guiding a communication card (150) into a multi-pin connector (160), said arrangement (200, 300) comprising a first guiding and aligning means (210) configured to securely guide a plurality of apertures (152) of said communication card (150) into a plurality of pins (165) of said connector (160); said first guiding and aligning means (210) including a pair of guiding members (215, 310) arranged opposite to each other, said pair of guiding members (215, 310) being configured to be slid into a pair of channels (154) configured on said communication card (150).

2. The guiding arrangement (300) as claimed in claim 1, wherein said first guiding and aligning means includes a plurality of stiffeners (315) configured to support said pair of guiding members (310).

3. The guiding arrangement (200, 300) as claimed in claim 1, wherein said first guiding and aligning means includes a pair of support members (230, 320) arranged opposite to each other, said pair of support members (230, 320) is configured to support said connector (160) thereon.

4. The guiding arrangement (300) as claimed in claim 1, which comprises a second guiding and aligning means configured to guide said communication card (150) along an axial plane of said plurality of pins (165).

5. The guiding arrangement (300) as claimed in claim 4, wherein said second guiding and aligning means includes a first snap (325) configured to abut said communication card (150) when said communication card (150) is guided along an axial plane of said plurality of pins (165).

6. The guiding arrangement (300) as claimed in claim 5, wherein said second guiding and aligning means includes a pair of second snaps (330) configured to abut and guide said communication card (150) when said communication card (150) is guided along said axial plane of said plurality of pins (165), wherein the plane of said second snaps (330) is orthogonal to the plane of said first snap (325).

7. The guiding arrangement (300) as claimed in claim 4, wherein said first and second guiding and aligning means are configured on a bracket (305).

8. The guiding arrangement (300) as claimed in claim 7, wherein a plurality of slots (335) is configured on said bracket (305) to facilitate air flow therethrough.

9. The guiding arrangement (300) as claimed in claim 7, wherein each of said bracket (305), said first and said second guiding and aligning means is of a non-metallic material.

10. The guiding arrangement (300) as claimed in claim 7, wherein a pair of holes (340) is configured on said bracket (305) to facilitate secure mounting of said connector (160) thereon.

11. The guiding arrangement (300) as claimed in claim 7, wherein said bracket (305) comprises a support portion (306) and a plurality of arms (307) extending orthogonally from said support portion (306).

12. The guiding arrangement (300) as claimed in claim 11, wherein said first guiding means is configured on said plurality of arms (307), and said second guiding means is configured on said support portion (306) and said plurality of arms (307).

13. The guiding arrangement as claimed in claim 11, wherein said bracket (305) includes a projection (345) extending from each of said arms (307), each of said projections (345) has a hole (350) configured thereon to facilitate mounting of said bracket (305).
